(19) United States
(12) Patent Application Publication
(10) Pub. No.: US 2024/0061544 A1
(43) Pub. Date: Feb. 22, 2024

(54) Metaverse antirape measures

(71) Applicant: Wesley John Boudville, Perth (AU)

(72) Inventor: Wesley John Boudville, Perth (AU)

(21) Appl. No.: 17/803,375

(22) Filed: Jun. 6, 2022

(51) Int. Cl. G06F 3/04815; G06T 19/00; G06T 13/40

(52) U.S. Cl. CPC G06F 3/04815; G06T 19/003; G06T 13/40

(57) ABSTRACT

We have methods against sexual harassment and virtual rape in a Virtual Reality site. The site offers a superpower to a victim. If attacked, she temporarily has enhanced strength or speed, letting her defeat the attacker. Another method has a bodyguard that co-inhabits the victim's avatar. The bodyguard and victim share the visual input of her avatar. If attacked, she hands control of her avatar to the bodyguard, who fights off the attacker, using her avatar's body. Afterwards, the victim regains control of her avatar.

### BACKGROUND

Recently, FACEBOOK Corp (which now has parent META Corp) discovered a problem with sexual harassment on its VR site. A female user accused other users of using their avatars to surround her avatar at close distance. This included unwarranted touching of her avatar. Facebook's reply was to impose a transparent barrier around each avatar on its site. This was a two foot “personal boundary”. It limits avatars to a first bump or high five. META suggested that in the future, when users are more comfortable with each other, this might be relaxed.

There have been other accounts of women being harassed, and their avatars “raped” in VR sites. It was suggested that this problem will not go away if the Metaverse grows.

### BRIEF DESCRIPTION OF THE DRAWINGS

FIG. 1 shows users Bob and Judy, with their avatars Bob′ and Judy′ in a VR site S.

FIG. 2 shows a new view spot for looking at avatars.

FIG. 3 shows a view spot and a new light source.

FIG. 4 shows Judy and a virtual bodyguard, both controlling avatar Judy′ in VR site S.

FIG. 5 shows a sexual assault on Judy′ and a countermeasure.

### DETAILED DESCRIPTION

What we claim as new and desire to secure by letters patent is set forth in the following. This application has the sections:
0] Definition of Metaverse;
1] Problems with META's methods;
2] Base method;
3] Following an avatar;
4] Multiple avatar belligerents;
5] Extending detection;
6] Superpower;
7] Other remarks;

0] Definition of Metaverse;

The Metaverse means different things to different people. We take a simple, minimalist operating definition that the Metaverse is Virtual Reality (VR) plus avatars. VR has been researched for decades. The use of avatars has recently become popular. Both ideas are combined here.

Others have waxed lyrical about what the Metaverse could be. Some of these ideas are metaphysical tirades or simply overly intricate.

1] Problems with META's Methods;

META Corp's methods have some issues.

1.a] Other independent VR sites may use different methods.

1.b] There are some normal innocent activities that involve avatars touching. Like ballroom dancing.

1.c] There can be future activities unique to the Metaverse, that involve touching. In an earlier US patent pending, “Metaverse avatar wearing a clickable link”, Ser. No. 17/803,218, filed 21 Mar. 2022, we described an avatar having a clickable link on its outer surface. A second avatar approaches and talks to the first avatar. Then (perhaps) the second avatar touches the clickable link and “jumps” to another site. In that pending, we suggested this can be a useful ability.

1.d] A recent (30 May 2022) news article (https://www.businessinsider.com/researcher-claims-her-avatar-was-raped-on-metas-metaverse-platform-2022-5) described how a researcher's avatar was sexually assaulted (raped) on a META VR site.

We suggest that Facebook's method is a good first start. But improvements are possible. We describe some of them here.

2] Base Method;

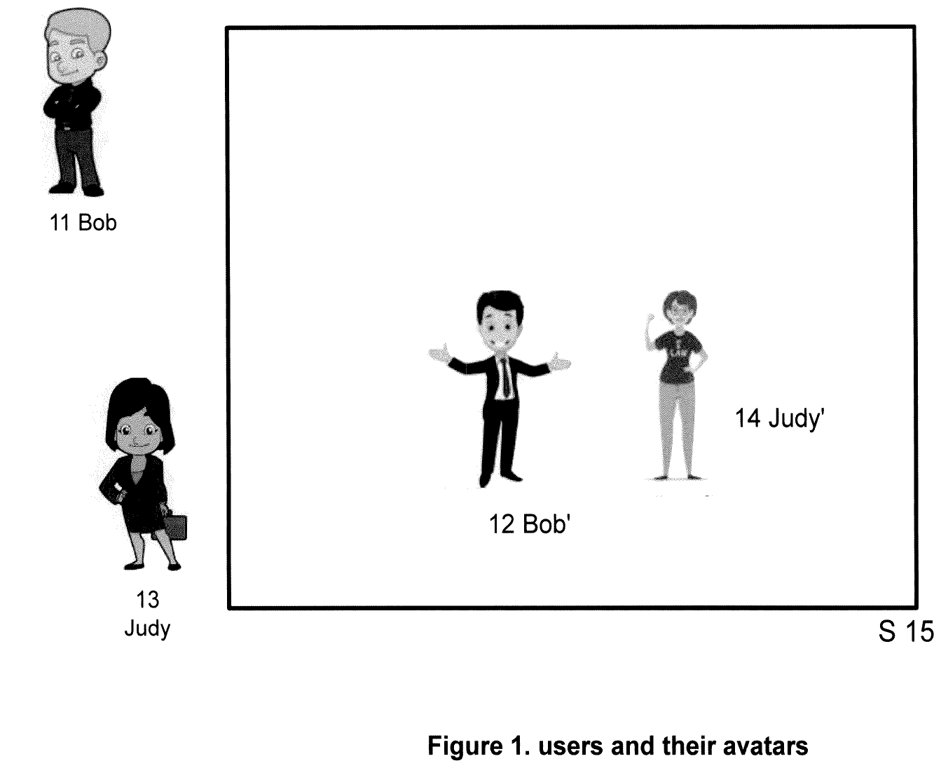

See FIG. 1. Consider 2 users, Bob 11 and Judy 13. Bob has avatar 12 Bob′ (pronounced “Bob prime”). Judy has avatar 14 Judy′ (pronounced “Judy prime”). The avatars are in a VR site S 15. They interact with each other in some manner.

Now consider what are the key differences between this interaction in VR and an interaction between Bob and Judy in real life. Ignore for the moment any possibility of bystanders.

Suppose in real life Bob sexually harasses Judy. Typically, she can describe what allegedly happened to authorities. But this often will not jibe with what Bob describes. A he said-she said scenario. And even if both are truthful, each person's memory of the incident can be very subjective and incomplete. Unless the incident happened in front of (eg) security cameras, such occurrences are possible.

But in site S, the situation is radically different. When 2 avatars are in a VR site, this means each avatar tells the site its current location (x, y, z), the orientation of its limbs, and the azimuth and elevation of its eyes. As well as any other details necessary for the site to draw the avatar. For the latter, imagine an avatar wearing a jacket, which is unbuttoned. This detail about the unbuttoning is necessary for the site to accurately draw the jacket draped on the body of the avatar. (So-called “cloth physics”.) Such information is needed for both avatars by the site. Remember that the avatars do not actually stand in a real space. The site then draws for the first avatar's eyes, what the eyes will see. Based mostly on the second avatar's location, limbs (etc), and based on the illumination (light sources) in the site. The site repeats this process for finding what the second avatar sees at the eyes of the second avatar.

This recording of the input to the eyes of an avatar cannot be avoided by the user of the avatar. Consider when an assailant avatar closes its eyes at the moment of assault, to prevent the site recording what the avatar sees. The avatar must publish its location and orientation to the site, so that the site can use these to draw information. Plus even an avatar being instructed by its user to close its eyes changes nothing. The visual light input going to the eyes can still be recorded by the site, even if the eyes are closed. This may necessitate the site being coded so that the computed image which is commonly described as being “seen” by an eye is extended to also mean “received at the closed eye”. Currently the latter might not be done. Mostly because in VR there is no physical need for an eye to blink, to moisten the eye, so an eye can remain open at all times in VR. For this reason, an avatar might not even be able to blink. But even so, the firmware of the site might have to be modified so that it computes what arrives at the outer surface of a closed eye, in this circumstance.

So far, the previous can describe a snapshot (photo) seen by each avatar. Actually, it describes 2 photos seen by each avatar, due to the slight differences in what is seen by the left and right eyes. Extrapolating, each avatar sees a sequence of photos that can be and is often combined into a stereoscopic video.

The site plays the central role in VR, unlike in real life, where what a person sees is in general not recorded by a camera. This observation leads to this consequence. Site S can store a copy of the videos it makes for Bob and for Judy. Normally in VR, due to storage and bandwidth constraints, a site might not do this.

Given the videos, suppose Judy complains later about Bob's harassment of her. The site can review its videos of the incident.

The site can offer this video feature as a competitive feature compared to other sites, who might lack this offering. Another competitive aspect is the duration of the video. S might offer a longer storage, meaning that this can give more evidence of an assailant's behavior before and after an incident.

The cost of video storage can be expected to be non-trivial. In general, the site cannot afford to store all the video it makes. So when should a video be stored? One answer is when Judy asks the site to do this. (This omits cases where she does not.)

Given this, should Bob be told? When S activates the storing of the video, it can turn on a signal (like a bright red bulb nearby) visible to Bob and third parties. This can be useful as a deterrent. But there is also a scenario where Judy does not want Bob to be told. She might be running a sting operation on him, based perhaps on Bob's previous behavior in that site or in other sites. Judy might be law enforcement or a private investigator amassing evidence against him. Or Judy might simply be wary and does not yet have evidence of bad actions by him. So she does not want to falsely accuse him.

VR is fundamentally different from real life. When the site starts storing Judy's video of what she sees, the site can also start storing video that Bob sees. There is little equivalent to this in real life. For example, does Bob′ point his eyes at Judy's erogenous zones (breasts and groin)? If so, to what extent does he do this? Plus, is this any proof of malicious intent? It is hardwired by evolution for many men to look at women's breasts and groins.

When we say “Bob's video”, we do not mean a video with Bob in it. We mean a video that arrives at his eyes (or his avatar's eyes). Likewise for “Judy's video”.

The site can store Bob's video unbeknownst to him.

If Judy asks the site to activate storage of her view, she might have to pay for this.

Can Judy ask the site to store Bob's view? If so, she might have to bear a separate fee.

If Judy asks the site to store Bob's view, the site might do so. But it could impose the condition that it will not manually review his video unless an incident happens. Probable cause may be necessary. If no incident happens, the site can later erase Bob's video.

Bob's video (as seen thru his eyes) is the sticking point. Judy asked for the video been by her avatar to be stored, so she gives explicit consent to that. But perhaps Bob never consented to his video being stored? However the site S can have a Terms of Use that was accepted by Bob when he first goes to S, that has a clause about a user's video being stored and analyzed.

When or if S has recorded enough material, it can initiate analysis. Perhaps in as close to real time as possible. If it then finds enough evidence, it can act against Bob. By terminating his avatar's presence in S, perhaps. An extra measure can be to terminate the use of any other avatars in S, whose owner is Bob. This assumes that Bob can own several avatars, which in general will be true. S can also promulgate its decision on Bob to other sites, which maybe independent sites. We anticipate that many such sites might act in concert against users and behavior that they commonly oppose.

Above, we described how a victim might ask the site to begin storing a video of what she sees. Another case is where the site S makes the decision to store video unprompted by a user request. There are several possible reasons.

A] An avatar has a complaint made against it from an earlier encounter. This complaint might be at a different VR site. We anticipate that competing VR sites might voluntarily share data about suspects, for mutual protection of sites and users.

B] The site says a user Bob fits a suspicious profile, even though there might be no complaints against him. The profile can be of his avatar's looks. For example, does his avatar have insignia of a “gang” or group of users with a record of unruly behavior. Or does his avatar originate or be associated with a site that has gotten many complaints from its users.

Or Bob might have done suspicious behavior at this site or other sites. The behavior was not definitive enough to warrant his expulsion. But a site might increase surveillance of him.

Or the site has detected the avatar carrying an item deemed likely offensive to many visitors to the site. Note that “offensive” in this context is very dependent on the norms of the site. An avant garde nightclub site might be very immune to many such items.

C] The site says that a user, Judy, fits a victim's profile. For example, is her avatar female? Is her avatar young, attractive? Is her avatar wearing skimpy clothing? Is her avatar topless? Some of these criteria can be controversial. Different sites have different norms of clothing and behavior. A topless female avatar might be unremarkable at a beach site or at a topless bar site.

D] The site says that a user, Judy, was a previous victim, either at the site or on other sites. So for her protection, the site will surveil her.

E] The site has an avatar depicting a child. It can conduct more intensive surveillance around it, for the child's protection.

3] Following an Avatar;

When Judy asks site S for help, S can also follow Judy′ as it moves thru S. The following can be via actually following Judy′ at some distance. Unlike real life, there might not be any need to be at a far distance. S can spin up a program, akin to a search spider, that follows Judy′ invisibly. In an earlier application, “Ghost spiders and zombie avatars of the Metaverse”, Ser. No. 17/803,238, filed 20 Jan. 2022, we described in more detail how a program can follow an avatar thru a VR site. We refer the reader to that application for more details.

In the current application, S can do both recording what Judy′ sees with her eyes, as well as having a program follow her thru S.

4] Multiple Avatar Belligerents;

Now suppose instead of just 2 avatars, there are more. Like avatars Dave′, and Todd′. Judy asks the site to store her video. She asks the site to also store Bob's video, but she does not ask this for the others. S can decide whether to store videos from Dave′ and Todd′. There is a greater cost burden. But S could decide that this is justified by the chance of detecting them acting in concert against Judy. S could decide to only also record the video of Dave′ if it notices that Dave′ is consistently closer to Judy and Bob than to Todd.

Proximity can play a major part in S deciding which avatars to record.

Another factor can be whether any of the avatars have a record of complaints against them.

5] Extending Detection;

The method of earlier can be greatly extended. When the site stores videos of what is seen by Bob and Judy, the site can also make and store a new video. This can be taken at a (x, y, z) location and direction of viewing (azimuth and elevation) that does not correspond to the eyes of either avatar or to any other avatar (if there are others nearby). The choice of this can be done automatically or manually. For example, if Bob and Judy are in a location where it would be difficult for a third avatar to see them, the site can put a view spot that is at a raised location (like a ceiling or rooftop), to give an unexpected (to Bob or Judy) vantage point.

A view spot is defined as a location where light is collected. It is a sink of light, rather than a source of light. The view spot also has an associated 2 dimensional plane, defined by a normal vector to the plane. Light is collected that is incoming on one side of the plane.

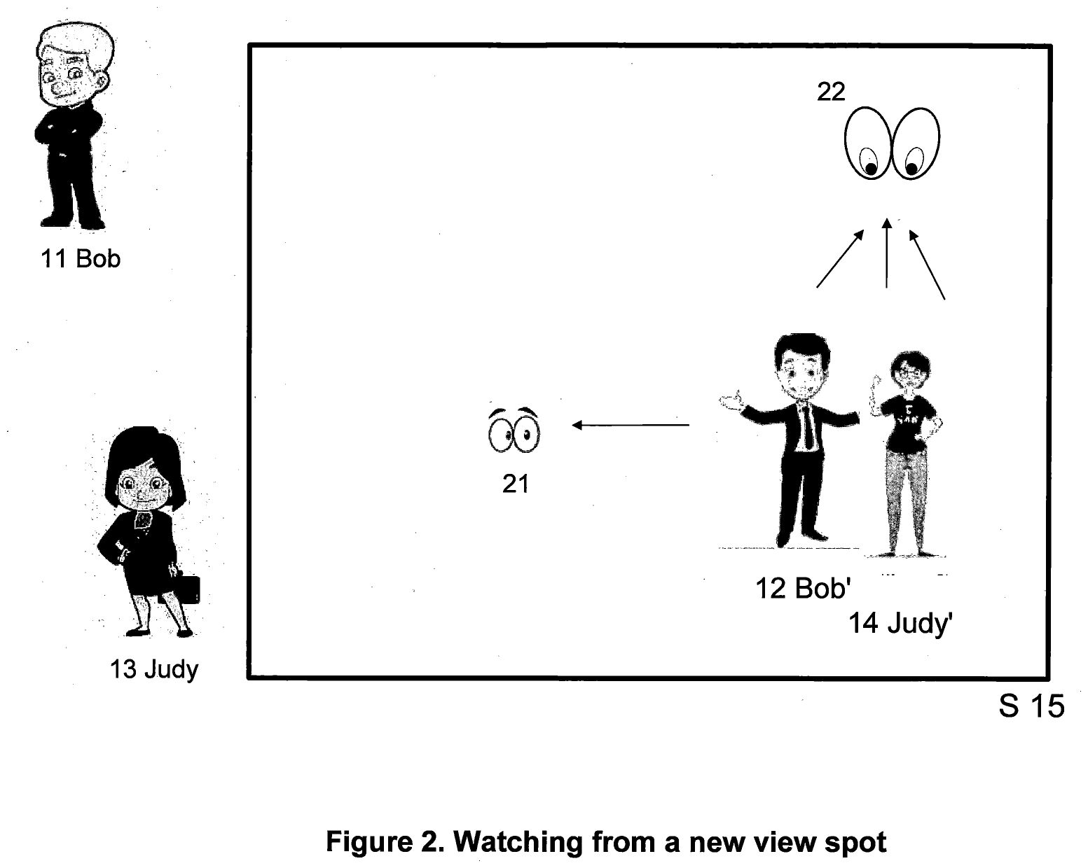

FIG. 2 shows view spots 21 and 22. View spot 22 is above the avatars. Note that there need not be a ceiling or roof where 22 is located. 22 can be floating in the air.

This exploits an aspect of VR that appears little known. The avatars might be in a location with only a dim light source nearby. So it appears to the avatars that they have some privacy. But the site can put a view spot nearby, and turn up the intensity of the light source. Where this new high intensity is only “seen” by the (new) view spot. The video collected by the view spot comes from high intensity light emanating from the light source. But for the normal views seen by Bob and Judy, they see only a dim light source. The advantage is that the increased light intensity can reveal more information about the incident. Like the locations and movements of the hands of both avatars.

In real life, such a thing is not possible. An investigator cannot just turn up the intensity of a light source, take some photos and then turn it down, without people nearby noticing. But the properties of VR allow for this cranking up of light intensity unbeknownst to the avatars. The site hides the increase in light intensity from the avatars, since this increase in light rays coming from the (new) light source is filtered away at the eyes of the avatars.

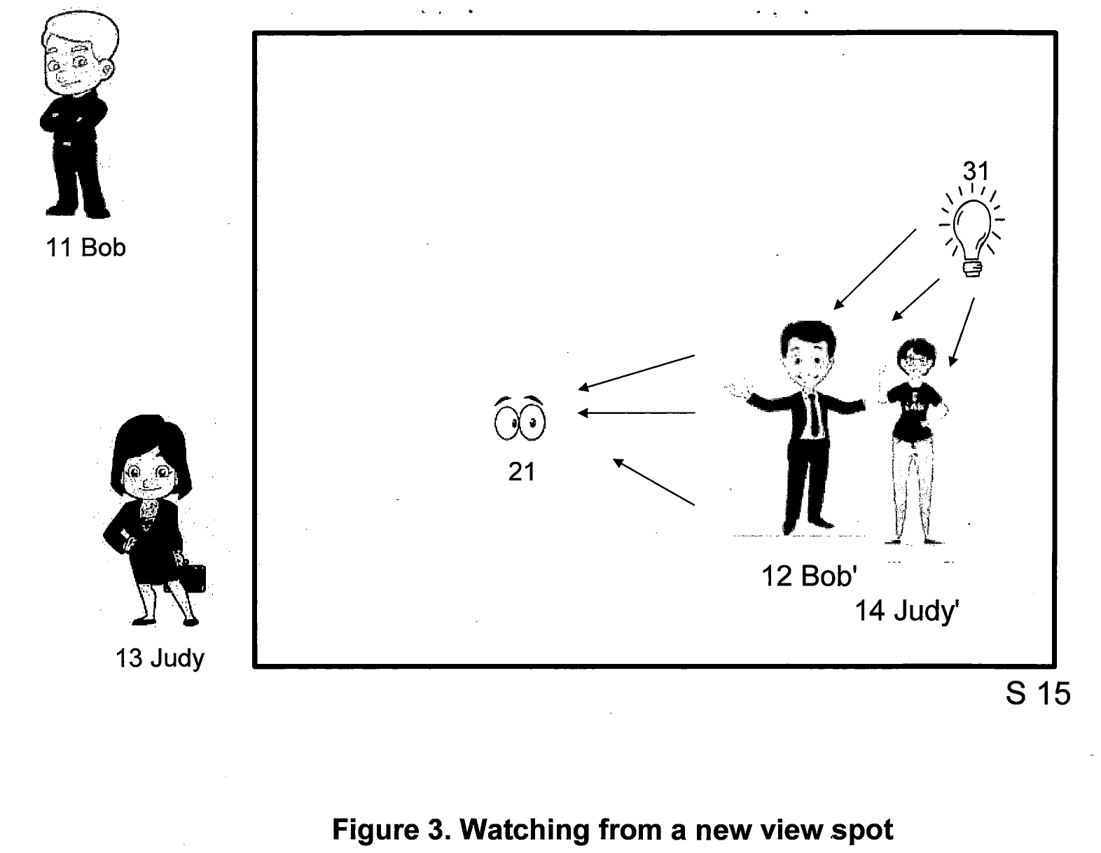

The previous steps described turning up (and then down) the intensity of an existing light source. Instead, a new light source could be temporarily inserted at some location, and the view spot collects the photo or video caused by the light coming from the new source. FIG. 3 shows a new light source 31, that is not present in what the avatars see. View spot 21 collects the light that originated from light source 31, as well as light from other sources. Where the latter are sources used by the avatars.

This technique can map to computing hardware. The site could have a CPU currently unused, perhaps for just this contingency. The CPU is spun up. It installs a new high intensity light bulb at a location bearing no light source. The CPU collects the video at a view spot from this source. While existing CPUs that service Bob′ and Judy′ keep on computing with the low intensity pre-existing light bulbs.

Note that because this is VR, the new light bulb can be anywhere. It does not need to be connected to an electrical wire that functions as a power source.

Suppose the frequency dependencies of the reflected light is known for the clothing worn by the avatars. And also the dependencies of the reflected light from the faces and bodies of the avatars. These might be for incident white light onto the faces, bodies and clothing. Or it might be for incident light in some frequency ranges. FIG. 3 can be extended to handle cases of incident light in certain frequency ranges, leading to reflected light being collected at a view spot. A light source could deliberately shine such an example of light. And the collected light can show details perhaps not present in the generic light being shone on the avatars.

6] Superpower;

Thus far, the measures described here were about how to take videos and store them. With perhaps the expulsion of an offender from a site, if this was deemed appropriate. We described how to take advantage of the virtual reality nature of the site to make a new light source that could not be seen by the suspect.

But more aggressive measures can be used in VR. Suppose the site determines that Bob has committed an offense against Judy. The site can do the following. It copies Judy′ to Judy″. It guides the original Judy′ to a separate and safe part of the site, or to another site. Judy″ takes the place of Judy′ in the site. Judy″ is under the direct control of the site. She defends herself successfully against Bob′, causing injuries to Bob′. The site might (or might not) take control of Bob′, leaving Bob only able to watch as Bob′ is systematically injured by a superior Judy′.

The site might deliberately create uncertainty, by leaving it ambiguous whether the site was actively performing the actions, or it was done by Judy in control of Judy′.

The effect can be traumatic enough to deter him from future offenses.

A variant is where the site takes control of Judy′ while leaving Judy as a passive observer inside the skin of Judy′. Judy watches while Judy′ overpowers Bob′. This can be cathartic for Judy, lessening any trauma she might have received earlier. Here, thru coding, Judy′ can be faster and stronger than Bob′.

This can be extended. When Judy uses Judy′ to enter S, it can offer her a “superpower” feature, perhaps for a fee. If she is accosted in S, she activates it. She controls Judy′ but now Judy′ is much stronger or faster than the typical avatar in S.

Here there can be several choices.

One. Judy actively uses the enhancements against Bob′.

Two. She lets the site take over Judy′ and she just watches.

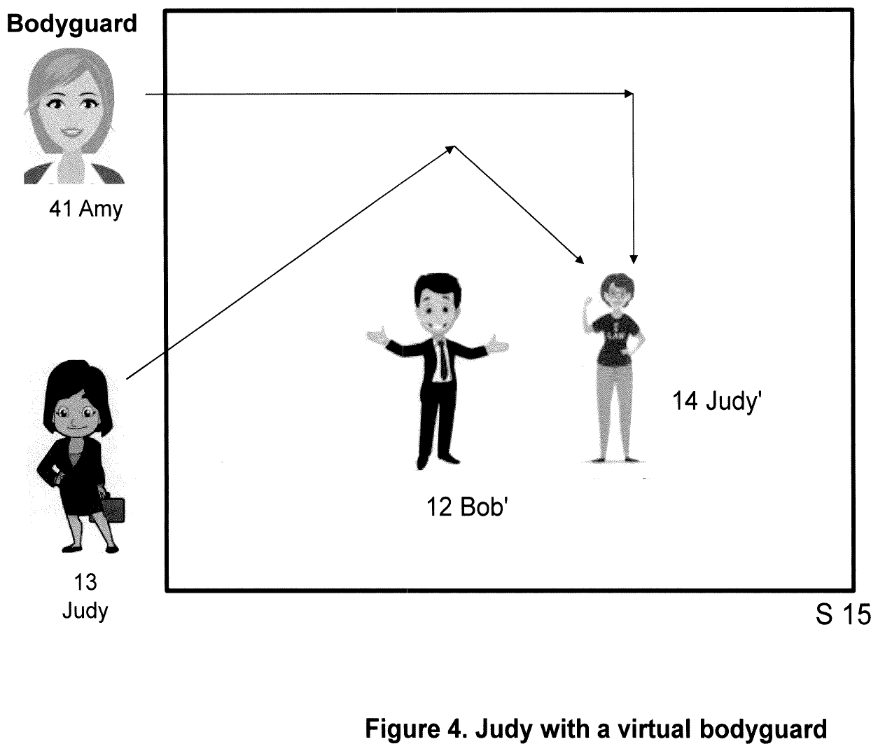

Three. Prior to the incident, Judy finds another user, Amy, to operate Judy′, perhaps with extra strength and speed. Amy could work for the site. Or Amy might be an independent operator. Amy is a “virtual bodyguard” that resides in the same avatar as Judy. See FIG. 4. It shows both Judy and Amy 41 controlling Judy′, though typically not concurrently.

This is a way that VR differs greatly from real life. In the latter, a celebrity might have a hulking bodyguard to protect her. But VR offers our innovation. When Judy runs Judy′, she can let Amy see the images and hear audio received by Judy′. Then when an incident of harassment occurs, Judy relinquishes control of Judy′ to Amy. Amy defends Judy′ while Amy is in the body of Judy′.

Largely, Judy is then just a passive observer thru Judy′, until such time as Amy gives back control. A variant is that Judy might have a “master switch” that lets her take back control, instead of having to wait for Amy to give back control.

When Amy is actively running Judy′, a variant is where Judy can still speak thru Judy′ into the VR of the site. The main reason for this is so that Judy can vocalize (eg) “Gosh darn you Mr Creep, take this!” while Amy is using Judy′ to pulverize him.

Amy might make a business of offering herself as a bodyguard to several users simultaneously, on this VR site or across several sites.

To the best of our knowledge, our virtual bodyguard, that is not a separate avatar, is a unique feature.

We described strength and speed. But Judy′ can also have enhancements like the adding of a face shield (eg a ski mask). In some cases, the shield might be invisible. Her clothing could be altered so that it functions as a body shield. Either while remaining visually the same, or perhaps where she now wears a “raincoat” or chain mail that is a shield. Judy′ might also be able to brandish a flask of fluid which she throws into her opponent's face. The fluid might function as battery acid. Or a knife or sword can appear in her hand.

Another variant is for a pet bodyguard to appear. This can be (eg) a (large) dog or tiger. This can be easily animated. Techniques for such animation are well developed. Or a humanoid bodyguard can appear, to defend the user. Unlike above, the humanoid or pet bodyguard are different avatars than Judy′.

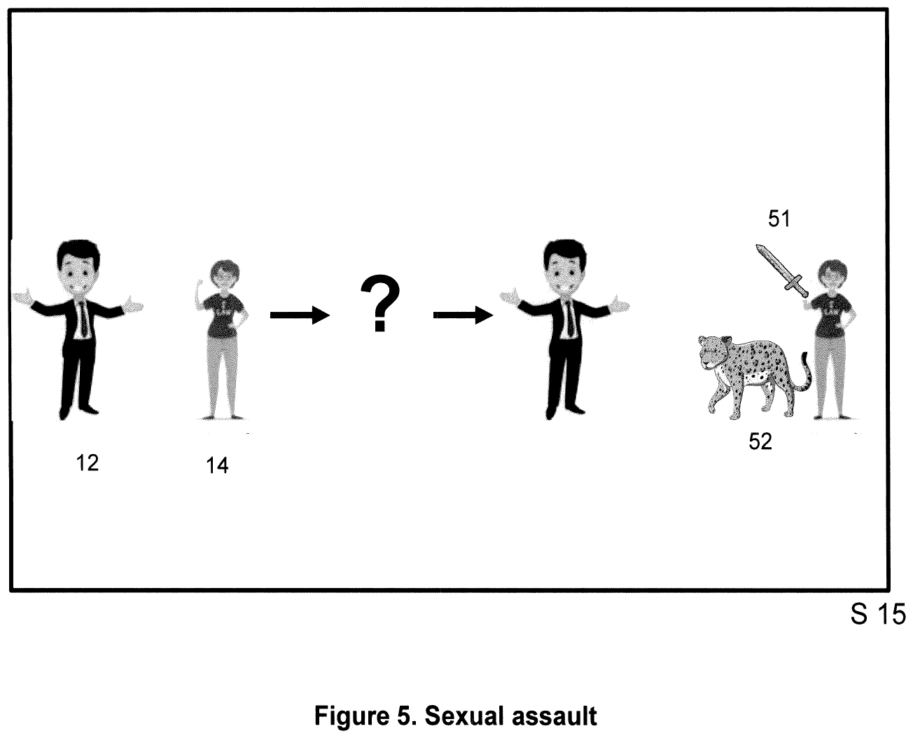

FIG. 5 shows an encounter between avatars Bob′ and Judy′. The question mark indicates a possible incident. After which, or during which, Judy′ now appears with a sword 51 and a companion leopard 52.

The fighting enhancement of an avatar is easily achievable in coding. There is over 30 years experience in making computer games where the main objective is for players to fight each other. Concepts like Hit Points are well established, and familiar to programmers. These lead right into implementations described here.

Another aspect is therapy for those who have been assaulted. Currently, the only recourse is typically for the victim to file a complaint with the VR site. But our invention lets the victim make her own remedy. And being able to “physically” stand up to the assailant can be empowering and therapeutic. On the other side of the coin, when an assailant receives his own medicine, and immediately after his actions, this may also act as an effective deterrent against him.

A variant of the above is to return to the scenario where Judy watches inside Judy′ while the site or bodyguard takes control of Judy′ to defend her. With a simulation of Judy′, this can be part of a training of Judy if she has been a real victim of assault. By Judy watching inside the skin of Judy′, a human expert controlling Judy′ can show Judy how to defend herself. Here, the scenario can be repeatedly replayed so that Judy can see and then Judy can keep control of Judy′ and do the actions herself.

When the site finds that Judy was indeed assaulted by Bob's avatar, the site can use the videos of Bob′ to replay the scene. By letting Judy re-enact the scene, with possible different actions by her, this can act to inoculate her against any trauma of the event. The site can have a bot control Bob′ to go against Judy′. Or, the site can let Amy control Bob′ to go against Judy′. Amy can act as a self defense instructor. She teaches Judy how to defend against Bob's actions.

There are these key features of the above discussion. The use of enhanced strength and speed in an avatar. And the voluntary ceding of control of the avatar to another user who acts as a virtual bodyguard, so that the latter user can use the avatar to attack the rogue avatar. The features are independent of each other. The owner of the avatar can decide if she wants only 1 feature, or both.

To protect against Judy abusing the power, S can (and likely should) turn on storage of what Judy and the other person see thru their avatars. After the event, S can do an analysis to check that Judy was warranted in activating her power. If not, she should be expelled from the site, and other sites informed, just as described earlier for an assailant.

7] Other Remarks;

The title of this application is “Metaverse antirape”. It might be objected that “rape” is not germane. In the Metaverse, rape is not possible. But sexual harassment is indeed possible in the Metaverse. A physical rape is not possible in the Metaverse. But a virtual rape can be. And given expected advances in computing, as the experiences in the Metaverse get more realistic, then we anticipate, sadly, that virtual rape will be a problem. Thus we offer this invention as a deterrent.

We claim:

1: A method of investigating sexual harassment in a Virtual Reality (VR) site;
the site having two visitors;
a first visitor using a first avatar;
the first avatar representing an adult human;
a second visitor using a second avatar;
the first and second avatars interacting;
the site putting a view spot near the avatars;
the site storing images computed at the view spot.
the site recording a first video seen at the eyes of the first avatar;
the site recording a second video seen at the eyes of the second avatar;
the site using the first and second videos and images seen at, the view spot to verify whether the first visitor was harassed or not.

2: The method of claim 1, where the site receives a harassment complaint from the first user, about the second avatar;
where the site charges a fee to the first user.

3: The method of claim 1, where the site determines that harassment occurred;
where the site expels the second user.

4: The method of claim 3, where the site prevents the use of the second avatar on the site.

5: The method of claim 3, where the site sends information about the harassment to other sites;
where the information includes an identity of the second user and an identity of the second avatar.

6: The method of claim 1, where the avatars move thru the site;
where the view spot follows the avatars.

7: A method of investigating sexual harassment in a Virtual Reality (VR) site;
the site having two visitors;
a first visitor using a first avatar;
a second visitor using a second avatar;
the first avatar representing an adult human;
the site providing one or more sources of illumination;
the first and second avatars interacting;
the site putting a new light source near the avatars;
the site putting a view spot near the avatars;
the view spot being at a different location than the new light source;
the new light source providing new illumination of the two avatars and surroundings;
the site computing images received at the view spot from light leaving the the new light source;
the site not computing the light received at the eyes of the first and second avatars, where the light originated at the new light source;
the site storing images obtained at the view spot.

8: The method of claim 7, where:
the site records a first video seen at the eyes of the first avatar;
the site records a second video seen at the eyes of the second avatar;
the site receiving a complaint from the first visitor about harassment by the second avatar;
the site using the first and second videos and images seen at the view spot to verify whether the first visitor was harassed or not.

9: A method of minimizing sexual assaults on an adult avatar in a VR site;
the site having two visitors;
a first visitor using a first avatar;
a second visitor using a second avatar;
the first avatar representing an adult human;
the site offering the first visitor a superpower feature;
the second avatar harassing the first avatar;
the first visitor starting the superpower feature;
the first avatar being granted enhanced strength and speed by the site;
the first avatar fighting off the second avatar.

10: The method of claim 9, where:
the site takes control of the first avatar;
the first visitor watches thru the eyes of the first avatar;
the site uses the first avatar to fight the second avatar.

11: The method of claim 9, where:
the first avatar wears a face shield put on the first avatar by the site;
the face shield making the face invulnerable to blows.

12: The method of claim 9, where:
the clothing of the first avatar acts as a shield;
the clothing making the first avatar invulnerable to blows.

13: The method of claim 9, where:
the first avatar obtains a weapon from the site;
the first avatar using the weapon against the second avatar.

14: The method of claim 20, where:
the weapon is one of (a) a knife, (b) a sword, (c) a club.

15: The method of claim 9, where:
the first avatar obtains a humanoid bodyguard avatar from the site;
the bodyguard defending the first avatar against the second avatar.

16: The method of claim 9, where:
the first avatar obtains a pet bodyguard avatar from the site;
the pet bodyguard defending the first avatar against the second avatar.

17: The method of claim 9, where:
the site records images presented to the first and second avatars by the site;
the site reviews the images;
the site decides if the use of the superpower feature by the first user was justified.

18: The method of claim 9, where:
the first user hires a human bodyguard;
the first user letting the bodyguard watch thru the eyes of the first avatar;
the first user being harassed by the second avatar;
the first user passing control of the first avatar to the bodyguard;
the bodyguard using the first avatar to defend against the second avatar;
the first user watching thru the eyes of the first avatar.

19: The method of claim 18, where:
the first user controls the mouth of the first avatar;
the first user vocalizes to the second avatar.

20: The method of claim 18, where:
the first user regains control of the first avatar from the bodyguard.
